(19) United States
(12) Patent Application Publication
(10) Pub. No.: US 2024/0126039 A1
(43) Pub. Date: Apr. 18, 2024

(54) STRAIN RELIEF FOR OPTICAL FIBER IN A CONDUIT

(71) Applicant: Precise Downhole Services Ltd., Nisku (CA)

(72) Inventors: Michael Melnychuk, Edmonton (CA); Daniel Keough, Edmonton (CA); Aleksei Andriianov, Edmonton (CA); Sean Begley, Edmonton (CA)

(21) Appl. No.: 18/485,722

(22) Filed: Oct. 12, 2023

Related U.S. Application Data
(60) Provisional application No. 63/415,520, filed on Oct. 12, 2022.

(51) Int. Cl. G02B 6/44

(52) U.S. Cl. CPC G02B 6/4459; E21B 47/135

(57) ABSTRACT

Disclosed are methods and systems for relieving strain of an optical fiber installed in a conduit downhole, wherein the conduit is purged with a purge gas to relieve mechanical strain of the fiber.

### CROSS-REFERENCE TO RELATED APPLICATION

This application claims the priority benefit of U.S. Provisional Patent Application No. 63/415,520, filed on Oct. 12, 2022, the entire contents of which are incorporated herein by reference.

### FIELD OF THE INVENTION

The present invention relates to methods and systems of strain relief of optical fiber in a conduit, installed in a well bore.

### BACKGROUND OF THE INVENTION

Distributed temperature sensing (DTS) systems are used to determine temperature profiles in environments such as a well bore. A laser transmits a light pulse into an optical fiber extending into the well bore. The light pulse reflects (backscatters) along the optical fiber to a fiber optic receiver and processing unit at the surface. The local temperature conditions at different depths of the well bore affect the local optical characteristics of the optical fiber, which results in reflections with different local shifts due to the Raman scattering effect. The reflections relative to the pulsed light are shifted in accordance with the temperature of the atoms along the fiber. The backscattered light is processed as a function of time to derive temperature as a function of well depth, with earlier backscatter indicating the temperature at relatively shallow depths, and later backscatter indicating the temperature at relatively deep depths. Such time-to-depth conversion is possible because the speed at which light travels through the fiber is known. The processing unit analyzes the reflected light to detect these amplitude shifts to compute a temperature profile along the length of the optical fiber.

Installation of an optical fiber in a conduit sometimes results in the fiber being strained within the conduit due to friction or other causes. It may be desirable to have methods of relieving strain of optical fiber in a conduit.

### SUMMARY OF THE INVENTION

In one aspect, this disclosure provides a method for relieving strain of an optical fiber in a conduit, installed in a well bore, the method comprising the steps of:
(a) providing a conduit in the wellbore, the conduit comprising at least one vertical leg, wherein the optical fiber is deployed in the vertical leg; and
(b) purging the conduit with a gas.

In a preferred embodiment, the conduit has two connected vertical legs, wherein the conduit is purged downward through one vertical leg and returns upward through the other vertical leg. The optical fiber may be in the downward leg or the upward leg. In some embodiments, the two vertical legs may be connected by a turnaround sub.

In some embodiments, the gas may comprise an inert gas such as nitrogen or argon and the step of purging the conduit with a gas comprises flowing the gas under pressure. In some embodiments, the conduit is purged in a first direction through one vertical leg, and if necessary, in a second direction opposite to the first direction through the other vertical leg.

In another aspect, this disclosure comprises a method of relieving strain in an optical fiber in a conduit in a well bore, the conduit comprising a check valve disposed at or near a lower end of the conduit, the method comprising the step of purging the conduit with a gas.

In another aspect, disclosed is a system for relieving strain in an optical fiber installed in a conduit in the wellbore,
(a) the conduit comprising a pair of vertical legs connected by a turnaround section connecting the bottom end of the vertical legs, wherein the optical fiber is deployed in one of the vertical legs of the conduit; or the conduit comprising a single leg including the optical fiber and a lower check valve;
(b) a source of purge gas connected to the conduit to purge the conduit with a gas.

In some embodiments, the conduit has a pair of vertical legs, and the source of purge gas is connected to both vertical legs, such that the conduit may be purged with a gas in a first direction, and purged again in the opposite direction. In some embodiments, the conduit has a pair of vertical legs and a check valve disposed at or near the turnaround.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 is a schematic drawing of a DTS system of the present invention including a processing unit and an optical fiber.

FIG. 2A is a schematic drawing of system for reducing strain in FBGs on an optical fiber deployed into a well bore. FIG. 2B is a schematic drawing of an alternative embodiment having a turnaround sub.

FIG. 3 is a schematic drawing of an alternative embodiment, having a single leg conduit and a downhole check valve.

### DETAILED DESCRIPTION OF THE INVENTION

Definitions. The invention relates to optical fibers installed in a conduit and deployed in a well bore, such as a distributed temperature sensing (DTS) system using optical fibers. Any term or expression not expressly defined herein shall have its commonly accepted definition understood by a person skilled in the art.

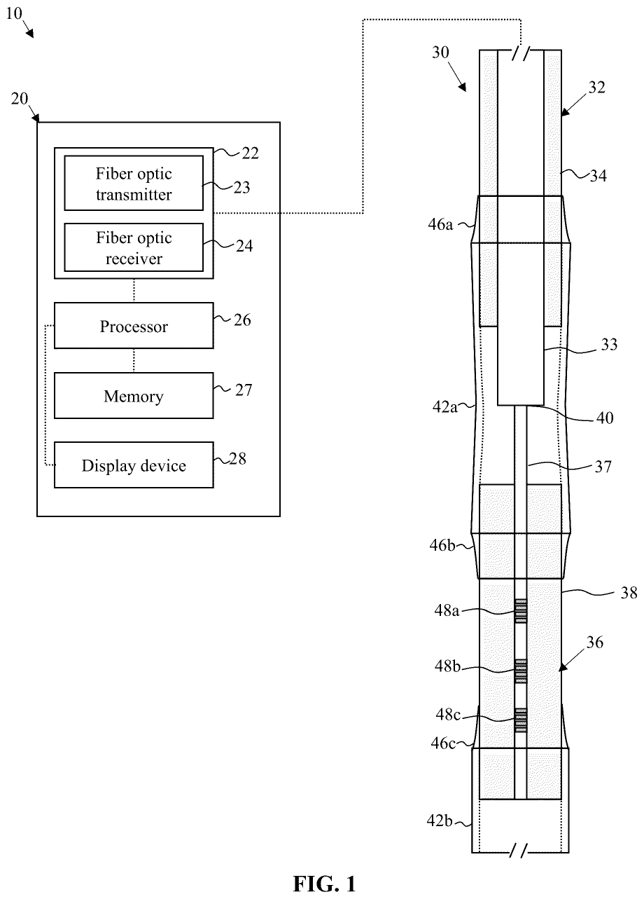

DTS and FBG System. FIG. 1 shows an embodiment of a DTS system (10) including a processing unit (20) and an operatively connected optical fiber (30). The processing unit (20) includes a fiber optic transceiver (22) including a fiber optic transmitter (23) and fiber optic receiver (24). The fiber optic transmitter (23) uses a light source such a laser or light emitting diode to convert electrical signals to optical signals that are transmitted into the optical fiber (30). In some embodiments, the optical fiber may comprise a single-mode (SM) fiber or a multi-mode (MM) fiber, or a combination of SM and MM segments spliced together. At least one integrally formed fiber Bragg grating (FBG) is provided along the length of the optical fiber, such as at the distal end of the optical fiber.

The fiber optic receiver (24) uses semiconductor devices such as photodiodes and photodetectors to convert optical signals received from the optical fiber (30) to electrical signals. Fiber optic transceivers (22) are known in the art and commercially available. The processing unit (20) includes a processor (26) operatively connected to the fiber optic transceiver (22) and a memory (27) storing instructions executable by the processor (26) to implement methods for computing temperatures based on signals generated by the fiber optic receiver (24) in response to optical signals from the optical fiber (30).

In some preferred embodiments, the processing unit (20) comprises both a Raman processing unit which processes optical signals from the optical fiber in accordance with Raman scattering phenomena, and a Brillouin processing unit which processes optical signals from fiber Bragg gratings in accordance with Brillouin scattering phenomena. The computations by which the processing unit(s) derive temperature data are known in the art, and do not by themselves constitute the present invention. The Raman and Brillouin processing units may be separate units and connected to the optical fiber by an optical switch, or may be a hybrid unit configured to process the optical signals in series or in parallel.

Although FIG. 1 shows the processor (26) and memory (27) as a single block, they may comprise a plurality of discrete components, such as a microprocessor with firmware attached to the fiber optic transceiver (22) and an operatively connected general purpose computer (e.g., a desktop, laptop, tablet, or smartphone computer) running software stored on a local memory or remote networked server. The processing units (20) also includes a display device (28) operatively connected to the processor (26) for displaying information in graphical form relating to the computed temperature profile and its calibration. The processing unit (20) may include or be connected to a power supply (not shown), and further include input devices (not shown) such as a keyboard, computer mouse, or touch screen operatively connected to the processor.

In some preferred embodiments, the optical fiber (30) comprises a multi-mode (MM) optical fiber segment (32) and a single-mode (SM) optical fiber segment (36) connected to the end of the MM optical fiber segment by a splice (40). The MM optical fiber segment (32) and the SM optical fiber segment (34) have light transmitting cores (33) and (37), respectively, surrounded by a reflective cladding (34) and (38), respectively, which may include buffer and jacket layers. As known in the art, MM optical fiber and SM optical fiber are distinguished by the diameter of their cores; MM optical fiber segment (32) has a core (33) with a diameter of about 50 μm to 62.5 μm, allowing for light transmission in multiple rays, whereas SM optical fiber segment (36) has a core (37) with a diameter of about 9 μm, allowing for light transmission with less rays. The splice (40) is an optically transmitting connection between the cores (33) and (37), such as a fusion splice. Splicing an MM optical fiber to an SM optical fiber is known to create issues with signal loss, but it has been found that the spliced optical fiber (30) remains effective for its intended purpose, even at lengths of about 2000 meters or more.

In alternative embodiments, the optical fiber may comprise only a SM fiber, or only a MM fiber, with FBGs distributed along the length of the optical fiber, or at a distal end of the optical fiber.

Strain Relief of FBGs.

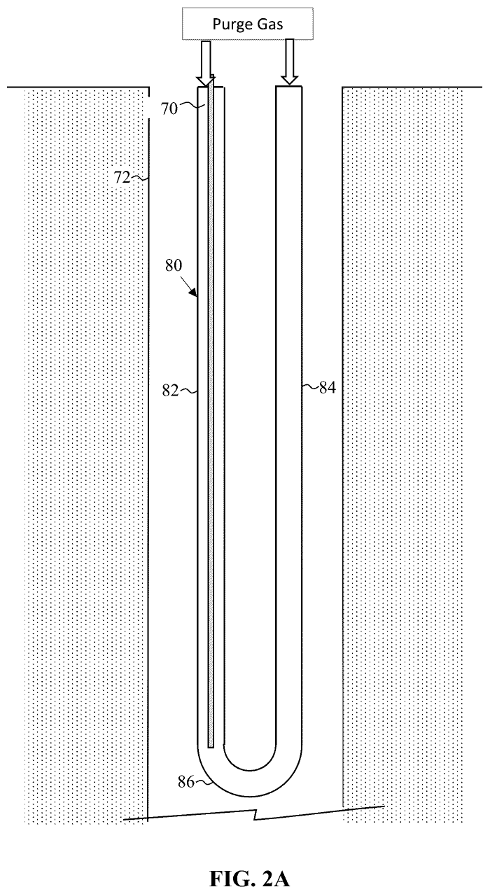

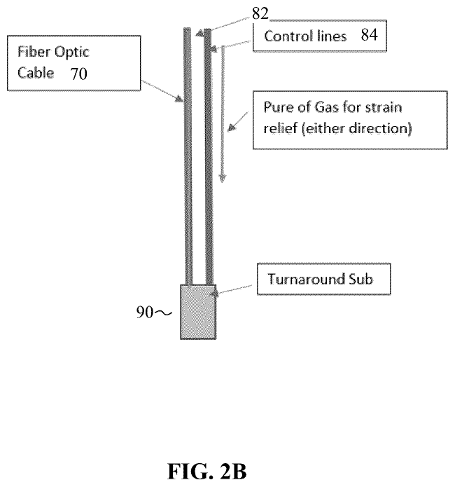

It is known that the shifted Bragg wavelength of an FBG is affected by mechanical strain as well as temperature. When using an FBG as a temperature sensor, it is therefore desirable to reduce the effect of mechanical strain on the FBG. FIG. 2A is a schematic drawing of system for reducing strain in FBGs on an optical fiber (70) deployed into a well bore (72). The optical fiber (70) is deployed into a conduit (80) having two vertical legs (82, 84) (referred to herein as a “fiber leg” and “non-fiber leg”, respectively) connected at their bottom ends by a turnaround section (86). In some embodiments, the turnaround section may comprise a discrete turnaround sub (90), as shown in FIG. 2B. The conduit may be a conventional capillary or control line as is known in the art. The optical fiber (70) can be deployed into the fiber leg of the conduit (80) using hydraulic or pneumatic fluid flow to “drag” the optical fiber (70) or a member attached thereto into the conduit, as is known in the art.

Without restriction to a theory, strain on the optical fiber (70) and its FBGs may result from thermal expansion of the conduit and/or friction or stiction at various contact points between the optical fiber (70) and the conduit. This strain may be relieved by purging the conduit (80) with a gas, preferably an inert gas such as nitrogen (N₂) or argon (Ar). Sufficient relief may be obtained by purging in one direction, however, in some cases it is preferred to purge in both directions. That is, the gas flows under pressure into the conduit in the direction from the one leg to the other, and then reversed. It may be preferred to first purge down the non-fiber leg (84) to the fiber leg (82). Purging the conduit with gas in either or both directions can reduce the effect of mechanical strain on the FBGs, so that they can be used to produce more accurate temperature readings.

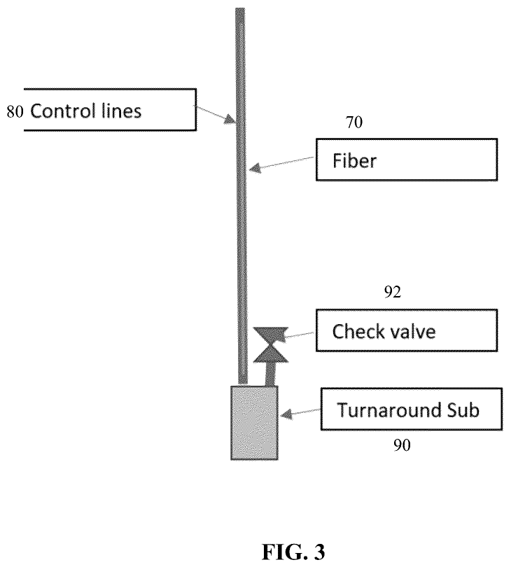

In an alternative embodiment, a gas purge method may be used in a single leg conduit, as exemplified by the schematic drawing of FIG. 3. In this case, the purging gas is directed down the conduit having the optical fiber, and exits the conduit through a downhole valve, such as a one-way check valve (92). The check valve may be attached to the open lower end of the conduit, or optionally disposed on a turnaround sub attached to the lower end.

Gas purging may be combined with other methods of strain relief, such as mechanical jarring of the conduit.

The flow rate and pressure of the purging gas may vary. Adequate gas flowing and pressure to relieve the stress may be ascertained by one skilled in the art, having regard to capillary length, exposed temperatures, gas being used, relative strain impact and direction of the purge.

Interpretation.

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A method for relieving strain in an optical fiber in a well bore, the method comprising the steps of:
(a) providing a conduit in the wellbore,
(i) the conduit comprising a pair of vertical legs connected by a turnaround section connecting the bottom end of the vertical legs, wherein the optical fiber is deployed in one of the vertical legs of the conduit; or
(ii) the conduit comprising a single leg including the optical fiber and a lower check valve;
(b) purging the conduit with a gas.

2. The method of claim 1 wherein the gas comprises nitrogen or argon.

3. The method of claim 1, wherein the conduit has a pair of vertical legs, and is purged with a gas in a first direction, and optionally repeated in the opposite direction.

4. The method of claim 3 wherein the first direction is into a non-fiber leg and up a fiber leg.

5. The method of claim 1 wherein the conduit has a single leg.

6. A method of relieving strain in an optical fiber in a conduit in a well bore, the conduit comprising a check valve disposed at or near a lower end of the conduit, the method comprising the step of purging the conduit with a gas.

7. A system for relieving strain in an optical fiber installed in a conduit in the wellbore,
(a) the conduit comprising a pair of vertical legs connected by a turnaround section connecting the bottom end of the vertical legs, wherein the optical fiber is deployed in one of the vertical legs of the conduit; or the conduit comprising a single leg including the optical fiber and a lower check valve;
(b) a source of purge gas connected to the conduit to purge the conduit with a gas.

8. The system of claim 7, wherein the conduit has a pair of vertical legs, and the source of purge gas is connected to both vertical legs, such that the conduit may be purged with a gas in a first direction, and then purged again in the opposite direction.

9. The system of claim 7, wherein the conduit has a pair of vertical legs and a check valve disposed at or near the turnaround.

10. The system of claim 7, wherein the conduit comprises a single leg.
